(19) United States
(12) Patent Application Publication
(10) Pub. No.: US 2008/0015983 A1
(43) Pub. Date: Jan. 17, 2008

(54) SYSTEM AND METHOD FOR SUBSCRIPTION-BASED MOBILE ELECTRONIC MOVIE TICKETING

(76) Inventor: Stacy G. Spikes, New York, NY (US)

Correspondence Address: PILLSBURY WINTHROP SHAW PITTMAN, LLP, P.O. BOX 10500, MCLEAN, VA, 22102, US

(21) Appl. No.: 11/614,651

(22) Filed: Dec. 21, 2006

Related U.S. Application Data
(60) Provisional application No. 60/752,523, filed on Dec. 21, 2005.

(51) Int. Cl. G06Q 40/00; G06F 17/30

(52) U.S. Cl. 705/40; 705/44

(57) ABSTRACT

A subscription-based mobile electronic movie ticketing system and method allows a subscriber can pay a certain fee in exchange for access to a number of movies at one or more movie theaters for a certain period. In some embodiments, the electronic movie ticketing system allows subscribers to search movie listings, movie venues, and show times on a mobile device. In some embodiments, the electronic movie ticketing system also allows subscribers to purchase and redeem tickets using their mobile device. In some embodiments, the subscription ticketing system monitors subscriber activity and provides incentives based on that activity.

This application claims the benefit of U.S. Provisional Application No. 60/752,523, filed Dec. 21, 2005, which is herein incorporated by reference in its entirety.

### FIELD OF THE INVENTION

The invention relates to the field of subscription-based electronic event ticketing.

### BACKGROUND OF THE INVENTION

Paper and electronic ticketing systems are known. For example, in a paper ticketing environment, a user purchases tickets for a movie (or other) event often at a location of the event before the start of the event. Sometimes, the user may purchase tickets in advance by calling a ticketing agent or purchasing the tickets online. The tickets are either sent to the user through the mail, may be printed at home, or may be picked up at the movie theater (or other event location). Self service kiosks are also used at movie theatres (and other venues), but often these kiosks have lines. Other electronic ticketing techniques are known.

Additionally, ticket sales for movies are typically based on a pay per movie basis.

Current ticketing systems have other drawbacks as well.

### BRIEF SUMMARY OF THE INVENTION

One aspect of the invention relates to an electronic subscription-based movie ticketing system, whereby a subscriber can pay a certain fee for access to see a number of movies at one or more movie theater for a certain period. For example, the subscriber may pay a monthly fee and be entitled to see as many movies as the subscriber desires for the day or month. In some cases certain restrictions may be imposed, for example, based on the number of movies, the number of times the same movie may be seen, the movie theaters at which the movies may be viewed or other restrictions.

According to another aspect of the invention, to facilitate the ability for a subscriber to acquire movie tickets, an electronic subscription-based ticketing system may enable a subscriber with a mobile device including SMS capability to text message to the system a request for one or more tickets for a movie (at least one of which may be covered by the subscription). One or more text message interactions between the subscriber and system may enable the subscriber to query available movies and specify a particular movie, a particular venue and a particular show time and date for a movie that the user wants to see. Other functions may be performed via the text messaging interactions.

Subject to processing and validation (and other desired steps) the system may send a return message to the subscriber with confirmation of ticketing for the desired movie at the desired location and time. The return message may include information to enable the subscriber to obtain the ticket or otherwise gain entry to the show. For example, the return message may include a code that the user can enter at a kiosk at the movie theater to print a ticket via the kiosk. Alternatively, the return message may include a bar code which can be scanned at the movie theater to print a ticket or gain entry without a ticket (e.g., via an automated turnstile that can read and validate the bar code). Other mechanisms for enabling the subscriber to print a ticket at the theater, remotely or otherwise may be used with the system.

The movie subscription ticketing system may include (or be operatively connected with) a subscription module for creating and managing subscriptions, a movie database that stores information regarding movies, show times and venues, a ticketing module that processes request for tickets (including tickets covered by the subscription and any additional tickets the subscriber may wish to purchase). The movie subscription ticketing system may also include various reporting and other modules as would be apparent. One or more of the services of the movie subscription ticketing system may be provided by a third party system. For example, the movie subscription ticketing system may be operated by one entity but the ticket processing functionality may be provided by another entity to which information is electronically transmitted from the movie subscription ticketing system and from which information is received by the movie subscription ticketing system and/or subscriber.

In some embodiments, movie subscription ticketing system operator may collect subscription fees from subscribers and pay the movie theater for the tickets at full price. Alternatively, the operator may contract with one or more movie theater or chain of movie theaters to obtain tickets at some discount. Different subscription levels and/or restrictions may be offered to subscribers and priced accordingly.

In some embodiments, movie subscription ticketing system may give incentives to subscribers that attend a particular movie or a particular number of movies within a week or month. In some embodiments, movie subscription ticketing system may offer discounts or other incentives based on prior viewing history. For example, if a subscriber attended a particular movie showing, then, when the movie is available on DVD or for digital download, the subscriber may be offered a discount on the purchase price of the DVD of that movie.

In some embodiments, subscribers may purchase electronic tickets outside of their particular subscription level or in addition to their particular subscription level. For example, a subscriber may be registered to purchase one electronic ticket for a particular movie. If the subscriber wanted to purchase an electronic ticket outside subscriber's subscription level or purchase additional electronic tickets (e.g., to see the movie with others), the subscriber can make a request through the system. The ticketing module would send the subscriber the additional electronic tickets or information related to the electronic ticket, such as a confirmation number, for an additional service fee.

### BRIEF DESCRIPTION OF THE DRAWINGS

FIG. 1 illustrates an environment in which a subscription ticketing system may be used according to various embodiments of the invention.

FIG. 2 illustrates various components of subscription ticketing system according to various embodiments of the invention.

FIG. 3 illustrates a representation of one example of an electronic ticket according to various embodiments of the invention.

FIG. 4 illustrates an example of operation of the ticketing system according to various embodiments of the invention.

FIG. 5 illustrates an example of one redemption scenario according to various embodiments of the invention.

FIG. 6 illustrates an example of another redemption scenario according to various embodiments of the invention.

FIG. 7 illustrates another example of a redemption scenario according to various embodiments of the invention.

FIG. 8 illustrates an example of another redemption scenario according to various embodiments of the invention.

FIG. 9 illustrates an example of a scenario according to various embodiments of the invention where the subscriber requests one or more ticket covered by the subscription and/or one or more tickets not covered by the subscription.

### DETAILED DESCRIPTION OF THE INVENTION

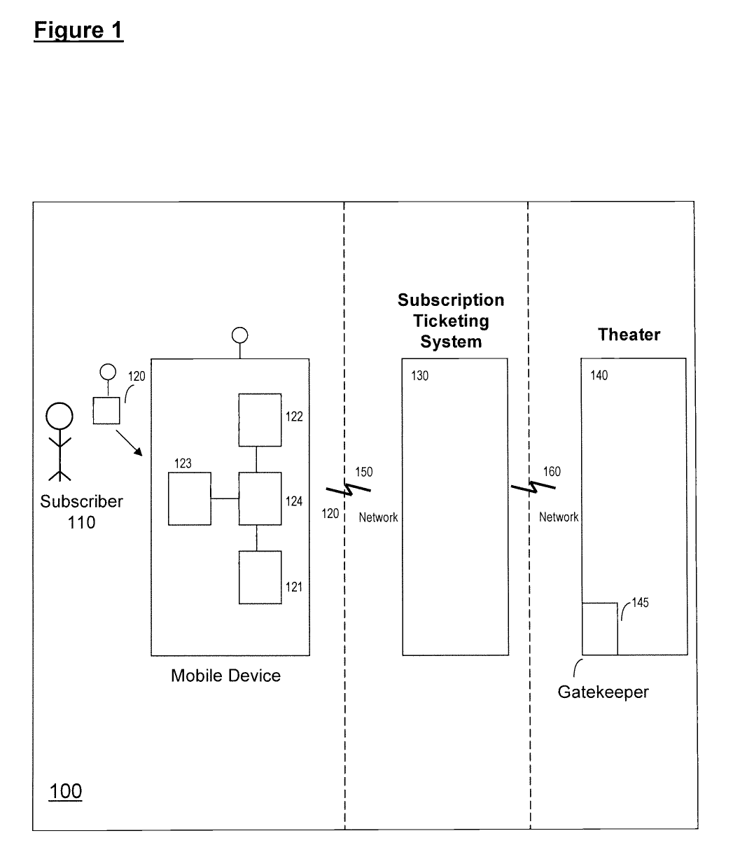

FIG. 1 illustrates an environment 100 in which a subscription ticketing system 130 may be used according to various embodiments of the invention. Subscribers 110 are users that have registered with subscription ticketing system 130. Subscribers may interact with the system using a mobile device 120 (or otherwise). For example, subscribers 110 may use mobile device 120 to interact with subscription ticketing system 130 in various ways including, but not limited to, searching movie titles, searching movie theater locations, and show times, specifying and/or purchasing tickets to one or more specific movies (for a given show time/location), and receiving information for redeeming tickets to enter the movies, or other interactions. Mobile device 120 may include an interface 121, an input device 122, a memory 123, and a controller 124. In some embodiments, interface 121 and input device 122 may be combined into a single device, such as a touch-screen interface. Mobile device 120 may be embodied as a cellular phone, personal digital assistant, or other portable wireless devices, with SMS or other text messaging capability.

Mobile device 120 communicates with subscription ticketing system 130 via any suitable network 150. Subscription ticketing system 130 receives and processes requests by subscriber 110 via mobile device 120. The request may include queries regarding available movies, request for a ticket to a specific movie showing and other requests. For example, searches for available movie listings may be based on one or more criteria supplied by subscriber 110 in the request, and/or in the subscriber's profile (e.g., location information, theater or theater change preference, desired show times and/or other information.

The system may also handle or facilitate various accounting and/or financial aspects associated with the electronic ticket, and delivers the electronic ticket or ticket related information to the mobile device 120.

Movie theater location 140 communicates with subscription ticketing system 130 through any suitable network 160. Movie theater location 140 may include a movie gatekeeper 145 (or other system) that processes tickets to the movie, such as verifying a validity of the electronic ticket and/or an identity of the ticket holder. Movie theater gatekeeper 145 may include a kiosk, turnstile, theater employee or other mechanism. In some cases the ticket(s) can be printed by the subscriber (e.g., at home, at a movie theater kiosk or otherwise). In other cases, information sent from system to the mobile device may be used directly to interact with the movie theater gatekeeper 145.

In some embodiments, network 150 and network 160 may be of the same type of network. For example, both networks may be a cellular telephone network. In other embodiments, network 150 and network 160 may be different types of networks. For example, network 150 may be a wireless cellular or data network and network 160 may be a wired telephone/data network. However, any suitable networks can be used.

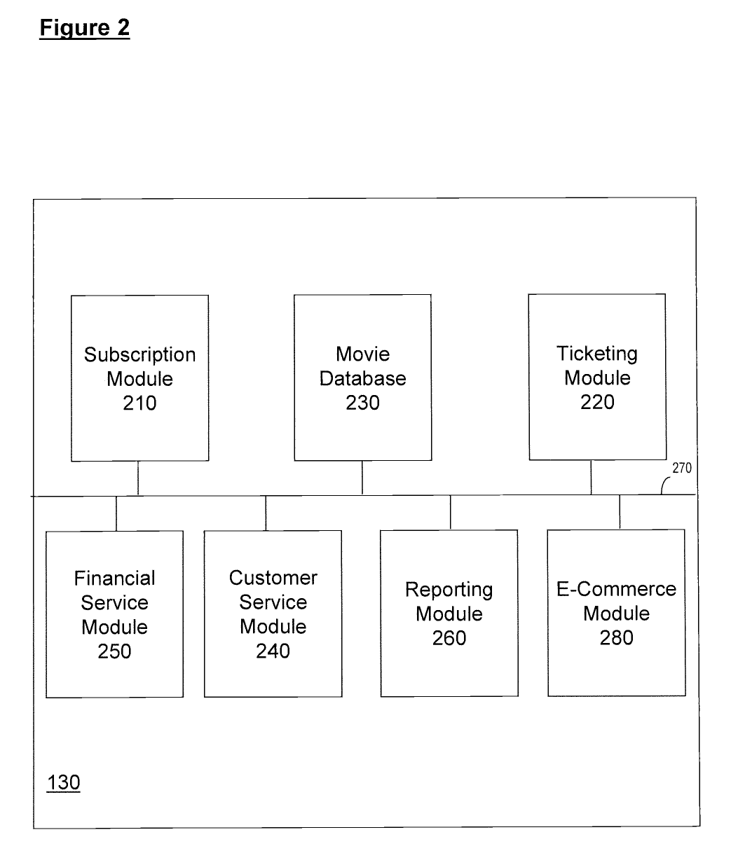

FIG. 2 illustrates various components of subscription ticketing system 1 30 according to various embodiments of the invention. Subscription ticketing system 130 may include a subscription module 210, a ticketing module 220, a movie database 230, a customer service module 240, a financial service module 250, a reporting module 260, and an electronic commerce module 280. In some embodiments, the components of subscription ticketing system may be discrete modules, however the functions described can be implemented in a variety of ways. One or more of the modules/functions may be implemented communicating through communication network 270 in one or more local or remote computer systems. In some embodiments, customer service module 240 and/or financial service module 250 may communicate with a third party system to provide subscribers with customer service or financial services, respectively.

Subscription module 210 performs various functions in connection with creating and managing subscriptions and subscriber profile information. The subscribers subscription information and/or other profile information may be used by the system to facilitate processing queries and/or ticket requests. The processing may be based at least in part, on the subscription level of the subscriber. Transactions performed by the subscriber through the system may be logged and associated with the subscriber identifier and/or subscriber profile. This and other information may be used by the reporting module and/or other system modules to facilitate administration and reporting functionality. In some embodiments, subscription module 210 may create a subscriber profile that includes various types of subscriber related information. For example, the profile may include subscriber identity information (e.g., subscriber name or other identifier such as an email address); subscriber address; subscriber payment information (e.g., credit card or other payment information); subscriber and movie preference information, such as preferred theater location, theater chain, show time, and preferred types of movies and/or other subscriber preference information; mobile device identification information for one or more devices associated with the subscriber/account; subscriber demographic information; and/or other subscriber profile information.

Movie database 230 may include a searchable memory for storing information concerning movies. Movie information may include, for each movie, a movie title, one or move movie theater locations where the movie is playing at each of the one or more locations, movie show times (start time and if desired ending times) for each date for each location, an amount of remaining tickets available for each movie showing (to the general public and/or to subscribers 110 of subscription ticketing system 130).

Ticketing module 220 communicates with mobile device 120 through any of a variety of communication protocols. According to one embodiment the communication protocol includes a text messaging protocol such as a short message service (SMS) or other messaging protocol. In some embodiments, ticketing module 220 performs functions including processing queries from subscribers and processing request for tickets.

Customer service module 240 may provides various account related services to the subscribers 110 of subscription ticketing system 130. These services may include assisting with account set-up, account maintenance, and technical troubleshooting. Other services may be performed by customer service module 240. Customer service module 240 may communicate with one or more third party customer service providers. In this case, the third party may communicate directly with subscriber 110 and/or indirectly through the system 130. Such communications may be through any suitable network 150, including without limitation through either a cellular or wired telephone connection. Subscription ticketing system 130 and/or third party customer service provider may provide service through any suitable electronic mechanism, including one or more web sites, via electronic mail, and/or other mechanisms not otherwise illustrated.

Financial service module 250 provides account services related to the subscribers 110. Such services may include subscription billing, account maintenance, ticket purchases not covered by a subscription, purchase of any ancillary products (e.g., DVDs, etc) and/or other financial related services. In some embodiments, one or more of the functions of the financial service module 250 may provide in whole or in part by a third party system (other than the subscription ticketing system operator). The third party financial service provider, which then communicates with the system 130 and/or subscriber 110 (directly and/or indirectly). Such communication may be through any suitable network, such as network 150. Other similar or related services may be provided by the financial service provider 250 as would be apparent.

Electronic commerce module 280 performs various functions in connection with providing incentives to subscribers based, in part, on prior viewing history. Incentives may include discounts to ancillary products. Ancillary products may be products related to movies that a subscriber has seen, for example, a DVD of the movie, a digital download of the movie, sound track of the or other products related to the movie and/or actors and actresses in the movie, for example.

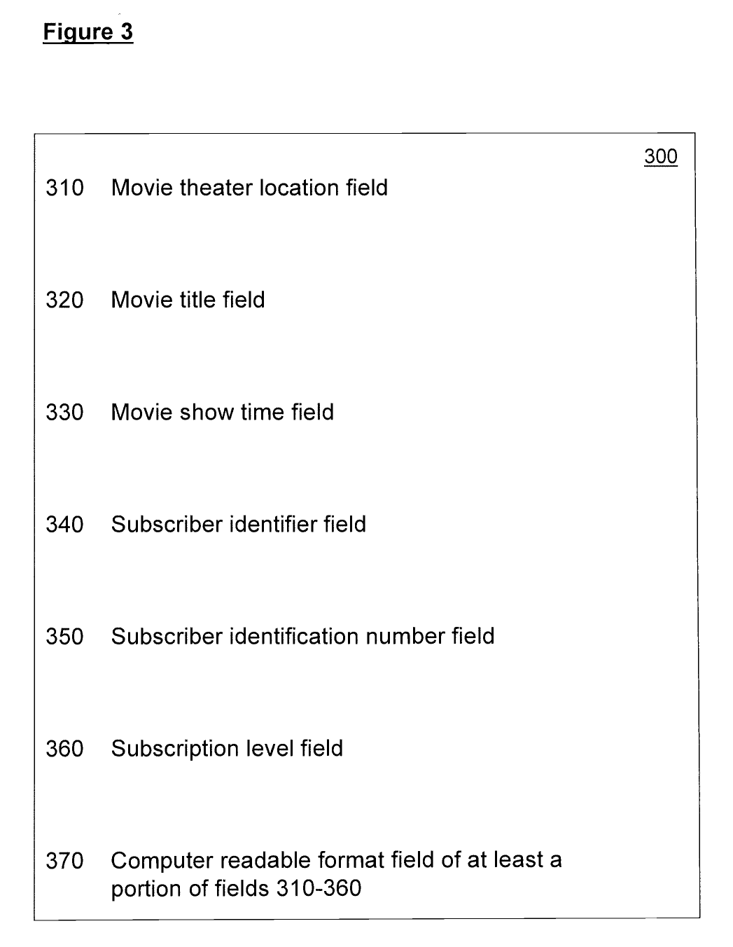

FIG. 3 illustrates a representation of one example of an electronic ticket 300 according to various embodiments of the invention. Electronic ticket 300 may have one or more fields including: a movie theater location field 3 10, a movie title field 320, a movie show time field 330, a subscriber identifier field 340 (e.g., a name), a subscriber identification number field 350, a subscriber subscription level field 360 and/or other fields. There may also be fields for the number and type of tickets (e.g., adult, child, senior, other). Additionally, all or some of fields 310-360 may be encoded into a computer readable format, such as a bar code 370.

Movie theater location field 310 may identify a name and an address for the movie theater, such as “Corner Movie Theater located at 100 Main Street, Fairfax, Va. 22033.” Movie title field 320 may identify a name of the movie, such as “Spiderman.” Movie show time field 330 may identify a show time (including either or both a start and/or end time), such as “8:00 pm” or “8:00 pm-10:00 pm.” Subscriber identifier field 340 may identify the subscriber's name or other identifier on the subscription account, such as “Mike Anderson” (or other identifier). Subscriber identification number field 350 may include a unique alpha-numeric string that identifies the subscriber's account, such as “0011223344.” The number of characters of the subscriber identification number is for illustrative purposes only and may be of more or less characters as would be appreciated. One or both of the subscriber identifier field 340 and/or subscriber identification number field 350 may be used. In some cases only one or the other may be used.

Subscription level field 360 identifies the subscriber service level which may include at least two tiers of service, a first level of service and a second level of service. The first level may be an entry level of service and costs the subscriber less per month than a second level of service. The first level may include fewer features and/or more restrictions of use than the second level. For example, the first level of service may allow subscribers to attend movies on Sunday-Thursday but exclude Friday and Saturday for a fixed monthly price of $34.95; whereas the second level of service may allow subscribers to attend movies seven (7) days a week for $44.95. Various features of the subscription may include access to first run movies, previews, opening nights, etc. Limitations may include days, times, number of movies per period (e.g., two per day or five per week) or other limitations. A digital representation of items 310-360 or a portion thereof may be encoded into a bar code 370.

In some embodiments, electronic ticket 300 may be stored in memory 123 of mobile device 120. In some embodiments, electronic ticket 300 may be stored in memory 123 of mobile device 120 with a back up copy of electronic ticket 300 stored at subscription ticketing system 130. In some embodiments, electronic ticket 300 may be stored at subscription ticketing system 130 allowing for real time retrieval by mobile device 120.

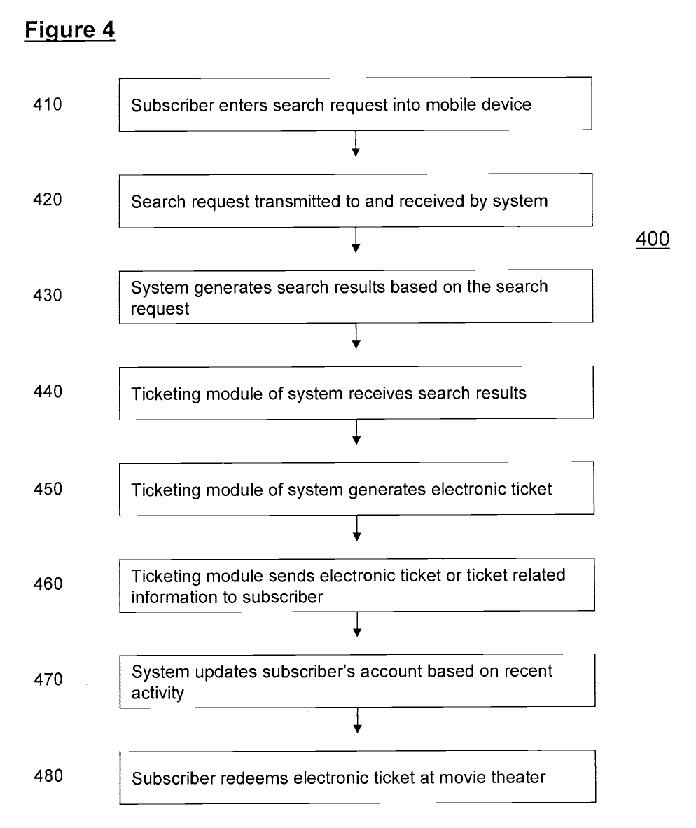

FIG. 4 illustrates an example of operation 400 of the ticketing system according to various embodiments of the invention. In an operation 410, the subscriber enters a search request into mobile device 120. The search request may include one or more search parameters such as a movie title, a movie location, a movie start and end time, and a number of tickets requested. In some embodiments, the search request may be entered using an unique alpha-numeric code, which represents a specific movie at a specific theater location at a specific time. This unique code may be published with conventional movie listings in a newspaper or website, for example. In some embodiments, a Movie Plus Short Code (MPSC) may be published with a movie listing in a newspaper or website. The MPSC is analogous to a VCR Plus code that are published in periodicals and are used for recording a specific show, from a specific channel at a specific time. In some cases subscriber profile information may also be associated with a search request. The subscriber may be identified by a mobile device identifier received from the mobile device issuing the request (based on mobile device identifier information in the subscriber profile), via subscriber entered information or otherwise.

In an operation 420, the search request is transmitted to and received by system 130. The system then queries the movie database 230 based on the request criteria and/or any subscriber related information (e.g., subscription level, preferences or other information). In an operation 430, the system 130 generates search results based on the results of the database query. The results may be sent to the mobile device from which the request originated and/or results may be sent to one or more modules in the system. For example, in an operation 440, the ticketing module 220 may receive the search results. In an operation 450, the ticketing module 220 generates the electronic ticket 300 (e.g., in response to the search results or a subsequent message from the subscriber 110 via mobile device 120). In an operation 460, the ticketing module 220 sends an electronic ticket 300 or ticket related information (e.g., confirmation code) to the mobile device 120 of subscriber 110. In an operation 470, the system 130 (e.g., via the subscription module 210 and/or a reporting module) updates the subscriber's account based on this recent activity. In an operation 480, subscriber 110 redeems electronic ticket 300 at movie theater location 140 through movie gatekeeper 145 in any one of a variety of ways, some examples of which are provided herein.

In some embodiments of the invention, when a subscriber 110 requests an electronic ticket 300 that is unavailable a list of alternatives may be sent to the mobile device 120 of subscriber 110. For example, if the subscriber searched for a movie entitled “Spiderman” showing at the Corner Cinema at 9:30 pm and the 9:30 show is sold out, the movie database 230 may send the subscriber one or more available show times at that particular cinema and/or at other locations near the subscriber. If the search yielded no exact or partial matches, then a message may be sent to the mobile device 120 of subscriber 110 indicating such and prompting the subscriber 110 to enter another search query. Other error or anomaly handing features may be provided.

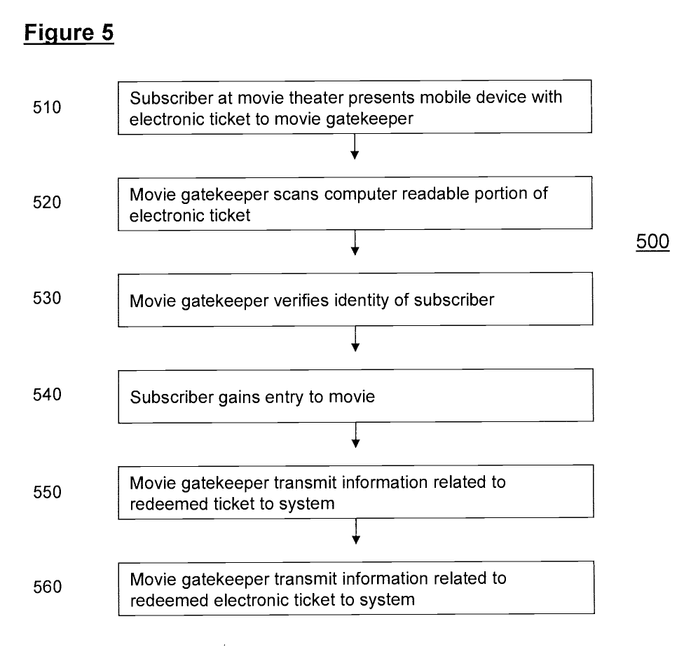

FIG. 5 illustrates an example of one redemption scenario 500 according to various embodiments of the invention. In an operation 510, subscriber 110 at movie theater location 140 presents mobile device 120 to movie gatekeeper 145 with electronic ticket 300. In an operation 520, movie gatekeeper 145 scans computer readable portion 307, e.g., bar code, of electronic ticket 300 with bar code reader, for example. In an operation 530, movie gatekeeper 145 verifies the identity of subscriber 110 with a subscriber identification card, e.g., driver's license, credit card, with information on electronic ticket 300. In an operation 540, subscriber 110 gains entry to movie theater location 140 upon proper completion of operation 540. In an operation 550, movie gatekeeper 145 transmits information relating to redeemed electronic ticket 300 to the system 130 (e.g., subscription module 210) to indicate that the subscriber actually redeemed the ticket.

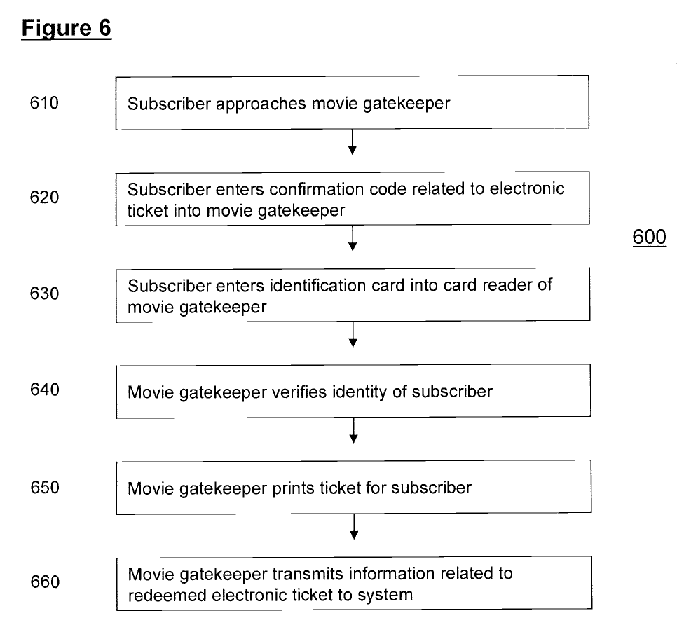

FIG. 6 illustrates an example of another redemption scenario 600 according to various embodiments of the invention. In operation 610, subscriber 110 approaches movie gatekeeper 145. Movie gatekeeper 145 may be an unmanned kiosk. In operation 620, subscriber 110 enters a confirmation code related to electronic ticket 300. Confirmation code may be transmitted to subscriber 110 from ticketing module 220 in the form of an email, text message, or other messaging delivery mechanisms.

Alternatively or in addition to the confirmation code, in operation 630, subscriber 110 enters an identification card (e.g., a credit card or other identification, which may be associated with the subscriber profile) into a card reader of the kiosk. In operation 640, kiosk verifies identity of subscriber 110 based on the confirmation code and/or identification card. Other verification techniques may be used. Upon successful verification by the kiosk, in operation 650, the kiosk prints a ticket for subscriber 110. In operation 660, kiosk transmits information regarding the redeemed electronic ticket 300 to system 130 (e.g., to subscription module 210, a reporting module 260 or other module(s)).

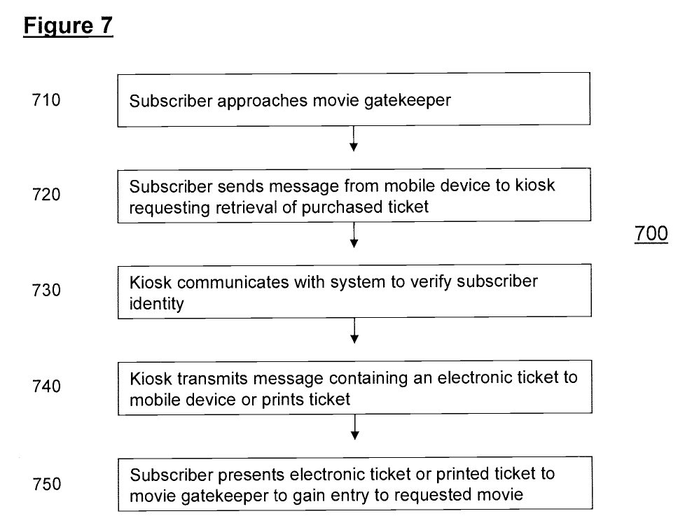

FIG. 7 illustrates another example of a redemption scenario 700 according to various embodiments of the invention. In operation 710, subscriber 110 approaches movie gatekeeper 145. Movie gatekeeper 145 may be an unmanned kiosk capable of sending to and receiving messages from mobile device 120 (e.g., via text messaging, blue tooth and any other suitable communication protocol). In operation 720, subscriber 110 sends a message from mobile device 120 to the kiosk requesting retrieval of a purchased ticket. The message may also contain authentication information such as a confirmation number, mobile device identifier or other authentication information. In operation 730, the kiosk communicates with subscription module 210 to verify subscriber identity and/or authorization to receive a ticket to the requested movie.

In operation 740, the kiosk transmits a message containing an electronic ticket 300 to mobile device 120 or prints a ticket. In operation 750, subscriber 110 presents an electronic ticket 300 or printed ticketed to movie gatekeeper 145 to gain entry to the theater at location 140 showing the requested movie.

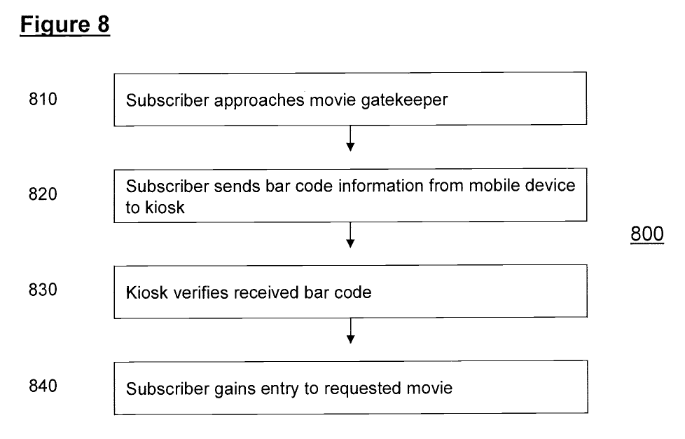

FIG. 8 illustrates an example of another redemption scenario 800 according to various embodiments of the invention. In operation 810, subscriber 110 approaches movie gatekeeper 145. Movie gatekeeper 145 may be an unmanned kiosk capable of sending and receiving messages with mobile device 120 (e.g., via text messaging, blue tooth or other suitable communication protocol). In operation 820, subscriber 110 sends barcode information corresponding to a requested ticket from mobile device 120 to the kiosk. In operation 830, the kiosk verifies the received barcode. The verification may be accomplished by the kiosk comparing the bar code information previously received from or on behalf of system 130 or by communicating in real time with system 130 (e.g., via subscription module 210 and/or ticketing module 220). Assuming the verification is successful, in operation 840, subscriber 110 gains entry to the requested movie.

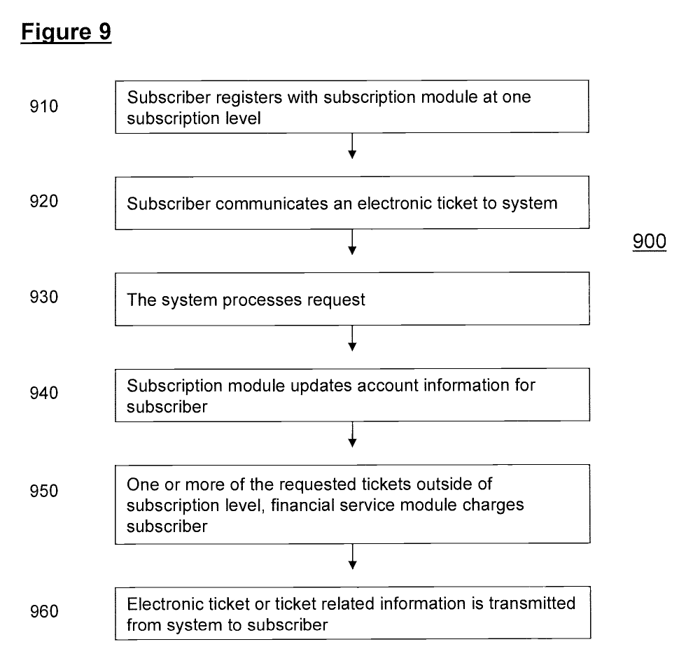

FIG. 9 illustrates an example of a scenario 900 according to various embodiments of the invention where the subscriber request one or more tickets covered by the subscription and/or one ore more tickets not covered by the subscription. In operation 910, subscriber 110 registers with subscription module 210 at one subscription level. In operation 920, subscriber 110 communicates an electronic ticket 300 request to system 130 (e.g., via ticketing module 220). The request may include one or more tickets covered by the subscription and one or more tickets not covered by the subscription. In operation 930, the system (e.g., ticketing module 220) processes the request. This processing may include determining what ticket(s) are covered by the subscription and which are not. The system 130 may compare the subscriber's ticket request against restrictions at the registered subscriber service level. In operation 940, subscription module 210 updates account information for subscriber 110 to reflect the purchase of an electronic ticket 300 covered by the subscription, if any. In operation 950, if one or more of the requested tickets is outside of the subscription level of subscriber 110, then financial service module 250 charges the subscriber the relevant purchase price for the remaining tickets requested. The payment may be made based on a payment option specified in the subscriber profile (e.g., credit card or other payment information) or based on information provided by the subscriber at the time of purchase. Other payment mechanisms may be used. In operation 960, electronic ticket 300 or ticket related information is transmitted from system 130 (e.g., ticketing module 220) to mobile device 120 of subscriber 110.

Due to the features of some subscription models that could be implemented (e.g. all you can watch movies for a fixed monthly fee), some subscribers could try to cheat the system by purchasing one subscription, but using the subscription to give tickets to friends or family or to resell tickets to strangers. Additionally, if tickets were able to be acquired by simply giving an account and/or password, the subscriber could share this information to enable others to make ticket requests directly. These problems typically are not an issue with pay as you go ticketing systems. Other fraud scenarios can be envisioned in a movie ticket subscription model/system.

To prevent or minimize this problem, various precautions are built into the system and/or business model. For example, the subscription may limit a subscriber to a certain number of movies per month and/or may limit the number of times any given movie can be seen by the same subscriber (e.g., once, twice or other suitable number). Another precaution maybe that the user must request tickets from a mobile device for which the mobile device identifier (e.g., cell phone number or other identifier) is provided at the time a subscription is created (or subsequently modified). Another precaution that may be used is that the subscriber may be required to use a credit card or other physical or biometric identifier at the movie theater location (e.g., kiosk) to obtain a printed ticket and/or to verify an electronic ticket. Other precautions can be implemented in the business model and/or system.

Various communication may be necessary or desired between (or on behalf of) the subscription ticket system 130 and one or more movie theaters. For example, upon purchase of one or more tickets through the system (or any related third party), ticket purchase information may be sent to the movie theater for which the ticket(s) was (were) purchased to enable the theater (e.g., via a movie gatekeeper) to verify the authenticity of the ticket and or enable the subscriber to print the ticket(s).

The features and functions of the system may be used in connection with events other than movies. In these cases, what is referred to herein as movie theater location 140 may be a venue other than a movie theater and the event may be other than a movie. For example the location may be a concert hall, a theatrical stage performance, a sports arena, a community convention hall, or a non-entertainment ticketed event, such as a lecture hall or seminar room. While the invention has such broader applicability it is particularly useful in connection with subscription models for events that may occur at a variety of venues.

The foregoing disclosure of examples of various embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

Any of the functions described as being performed by a module, component or system can in some embodiments be performed by one or more other module, component or system. One or more functions described as being performed by different modules, components or systems can be combined to be performed by one or more common module, component or system.

What is claimed is:

1. A method for granting access to a particular movie at a particular movie location at a particular show time via a subscription-based electronic movie ticketing system, the subscription-based electronic movie ticketing system having a plurality of subscribers each with a subscription to the electronic movie ticketing system, wherein under the subscription, each subscriber periodically pays a subscription fee that entitles said each subscriber to view a plurality of movies in at least one movie location within each period of time, the method comprising:
receiving a movie selection from the subscriber, the movie selection corresponding to the particular movie at the particular movie location at the particular show time;
determining whether the movie selection falls within a subscription level of the subscription being provided to the subscriber;
providing at least ticket information to the subscriber via a mobile device of the subscriber, the at least ticket information associated with an electronic ticket to the particular movie at the particular movie location at the particular show time via the electronic movie ticketing system;
receiving, at a gatekeeper located at the particular movie location, said at least ticket information;
receiving, at the gatekeeper, authentication information authenticating the subscriber; and
in response to said at least ticket information and said authentication information, granting the subscriber access to the particular movie.

2. The method of claim 1, wherein receiving a movie selection comprises:
receiving the movie selection via the mobile device of the subscriber, the movie selection corresponding to the particular movie at the particular movie location and a number of requested tickets for the particular movie.

3. The method of claim 2, further comprising:
determining whether the number of requested tickets for the particular movie exceeds a number of tickets provided under the subscription; and
retrieving payment information associated with the subscriber, the payment information used to facilitate billing the subscriber for a number of tickets that exceed the number of tickets provided under the subscription level.

4. The method of claim 3, wherein providing at least ticket information to the subscriber via the mobile device comprises providing at least ticket information for the number of requested tickets to the subscriber via the mobile device.

5. The method of claim 1, wherein providing at least ticket information to the subscriber via the mobile device comprises providing an electronic ticket to the subscriber via the mobile device.

6. The method of claim 5, wherein receiving, at a gatekeeper located at the particular movie location, said at least ticket information comprises:
scanning a bar code rendered on a display of the mobile device.

7. The method of claim 5, wherein receiving, at a gatekeeper located at the particular movie location, said at least ticket information comprises:
receiving a confirmation code entered by the subscriber.

8. The method of claim 5, wherein receiving, at a gatekeeper located at the particular movie location, said at least ticket information comprises:
receiving a confirmation code provided by the mobile device.

9. The method of claim 1, wherein granting the subscriber access to the particular movie comprising providing passage through a turnstile to the particular movie.

10. The method of claim 1, wherein granting the subscriber access to the particular movie comprising providing the subscriber with a physical ticket to the particular movie.

11. The method of claim 1, wherein receiving, at the gatekeeper, authentication information authenticating the subscriber comprises receiving credit card information from the subscriber.

12. The method of claim 1, wherein receiving a movie selection from the subscriber comprises receiving the movie selection from the subscriber via the mobile device of the subscriber.

13. The method of claim 1, further comprising:
receiving a search request from the subscriber regarding movies playing in movie locations; and
in response to the search request, providing the subscriber with a list of movies that correspond to the search request.

14. The method of claim 1, further comprising:
receiving a search request from the subscriber regarding movies playing in movie locations; and
in response to the search request, providing the subscriber with a list of movies that correspond to at least criteria associated with the subscriber.

15. The method of claim 13, wherein providing the subscriber with a list of movies that correspond to the search request comprises providing a list of movies for which tickets are available to the subscriber.

16. The method of claim 1, further comprising after determining that the movie selection does not fall with the subscription level of the subscription provided to the subscriber, retrieving payment information associated with the subscriber, the payment information used to facilitate billing the subscriber for a ticket associated with the movie selection.

17. A subscription-based electronic movie ticketing system that provides to a subscriber access to a particular movie at a particular movie location at a particular show time via a mobile device, wherein under a subscription to the electronic movie ticketing system, the subscriber periodically pays a subscription fee that entitles the subscriber to view a plurality of movies in at least one movie location within each period of time, the system comprising:
a subscription module that manages an account associated with the subscription of the subscriber and authorizes access to the system by the subscriber;
a database that provides search results regarding movies available to the subscriber in response to a search request from the subscriber;
a ticketing module that is responsive to a movie selection from the subscriber and that provides ticket information to the subscriber via a mobile device associated with the subscriber, the ticket information associated with an electronic ticket associated with the movie selection; and
a gatekeeper that receives the ticket information and authentication information from the subscriber and that provides to the subscriber access to the particular movie.

18. The system of claim 17, wherein the subscription module determines whether the movie selection is within the subscription of the subscriber and facilitates billing the subscriber for a ticket associated with the movie selection when the movie selection is not within the subscription of the subscriber.

19. The system of claim 17, wherein the ticket information provided to the subscriber via the mobile device is a bar code.

20. The system of claim 17, wherein the subscriber is offered incentives based on subscription history.
